(19) United States
(12) Patent Application Publication
(10) Pub. No.: US 2009/0122820 A1
(43) Pub. Date: May 14, 2009

(54) Method Of Driving A Laser Diode

(76) Inventors: Arkadi Trestman, Ashdod (IL); Yair Salomon, Jerusalem (IL); Israel Fishman, Ashkelon (IL)

Correspondence Address: BROWDY AND NEIMARK, P.L.L.C.;624 NINTH STREET, NW, SUITE 300, WASHINGTON, DC, 20001-5303, US

(21) Appl. No.: 11/817,807

(22) PCT Filed: Feb. 27, 2006
(86) PCT No.: PCT/IL2006/000257

§ 371 Date: Sep. 5, 2007

(30) Foreign Application Priority Data
Mar. 6, 2005 (IL) 167262

(51) Int. Cl. H01S 3/00

(52) U.S. Cl. 372/38.02

(57) ABSTRACT

A method of driving a block of diodes having low impedance by high power pulses. A high power signal is fed through an impedance-transforming device to a block of diodes. The block of diodes includes at least one laser diode. The impedance-transforming device is one of a group of transformer or quarter wave matching section.

### TECHNICAL FIELD

The present method relates to the field of optical recording and in particular to the method of driving a laser diode by high power pulses.

### BACKGROUND

Optical recording and reading of high capacity three dimensional memory storage medium utilizing two-photon absorption, such as the one described in the Patent Convention Treaty Publication WO 01/73779 requires for recording and reading high power laser pulses. The repetition rate of the pulses may vary in a large range. Existing laser driver circuits provide either high output power at low repetition rate or low power at high repetition rate. For driving a laser diode incorporated in the optical pick-up unit the existing laser driver circuits require special low impedance transmission lines otherwise the driver should be positioned in immediate proximity to the laser diode.

A method of driving a laser diode is disclosed in U.S. Patent Application Publication 2004/0258115 A1.

### BRIEF DESCRIPTION OF THE DRAWINGS

The disclosure is provided by way of non-limiting examples only, with reference to the accompanying drawings, wherein:

FIG. 1 is simplified schematic of an exemplary embodiment of an electronic circuit useful in the implementation of the method.

FIG. 2 is simplified schematic of another exemplary embodiment of an electronic circuit useful in the implementation of the method.

FIG. 3 is simplified schematic of the third exemplary embodiment of an electronic circuit useful in the implementation of the method.

FIG. 4 illustrates the optical power of a laser diode in RF operation mode driven at a frequency of 100 MHz by driver of FIG. 1.

### DETAILED DESCRIPTION OF THE METHOD

The principles and execution of the method described thereby may be understood with reference to the drawings, wherein like reference numerals denote like elements through the several views and the accompanying description of non-limiting, exemplary embodiments.

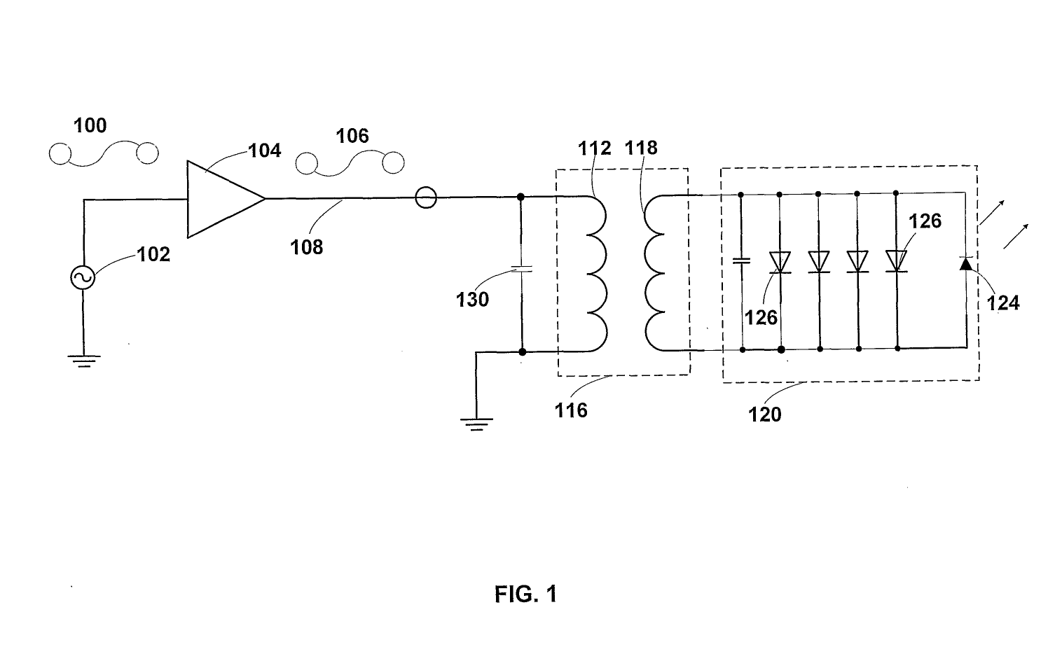

Reference is made to FIG. 1, which is simplified schematic of an exemplary embodiment of an electronic circuit useful in the implementation of the method. A signal generator 102 or other source of suitable signal generates an input signal 100. Input signal 100 may be a bi-polar signal of sinusoidal or other form, having a first and second polarity. Input signal 100 may include separate pulses or pulse bursts. Signal 100 is fed into a commercially available broadband power amplifier 104 such as Model 75A250 or similar available from Amplifier Research, Inc., Souderton, Pa., U.S.A. Standard transmission line 108 matching the output impedance of amplifier 104 connects output of amplifier 100 to a primary winding (input section) 112 of transformer 116. The term “winding” means an assembly of coils designed to act in consort to produce a magnetic flux field or to link a flux field. Standard transmission line 108 may have a 50 ohm, 75 ohm or any other impedance required to match the output impedance of amplifier 104. The length of transmission line 108 is essentially not limited.

A low impedance device, which may be a block of diodes 120 is coupled to a secondary winding (output section) 118 of transformer 116. Block 120 includes a laser diode 124 for example such as Model ML 101J19-01 or similar, commercially available from Mitsubishi Electric Corp., Tokyo, Japan, and one or more diodes 126 such as MA-4P404-30 or similar, commercially available from M/A-COM, Lowell, Mass. U.S.A., connected in parallel with laser diode 124. Laser diode 124 is typically forward biased where diodes 126 are reverse biased, or in the opposite to laser diode 124 direction. Laser diode 124 typically has low impedance. The negative part (first) of bipolar drive signal 106 may drive laser diode 124. Since only the negative (first) part of the bipolar drive signal drives laser diode it is actually driven by high power pulses. Diodes 126 conduct significant part of the positive (second) section/part of bipolar drive signal 106. Secondary winding 118 of transformer 116 is selected in such a way that it matches the impedance of block of diodes 120. Transformer 116 serves as an impedance-transforming or matching device. Capacitors 130 and 140 serve for fine impedance tuning respectively between amplifier 104 and primary winding 112, and block of diodes 120 and secondary winding 118. For example, the circuit operated at 100 MHz had the ratio of reflected to incident waves of 10:1. The only signal frequency limiting factor in such a circuit is the bandwidth of impedance-transforming device 116.

In some cases diode block 126 may be replaced by operating laser diode 124 at a positive offset. The offset is selected in such a way as to protect laser diode 124 from the damaging negative voltage drop.

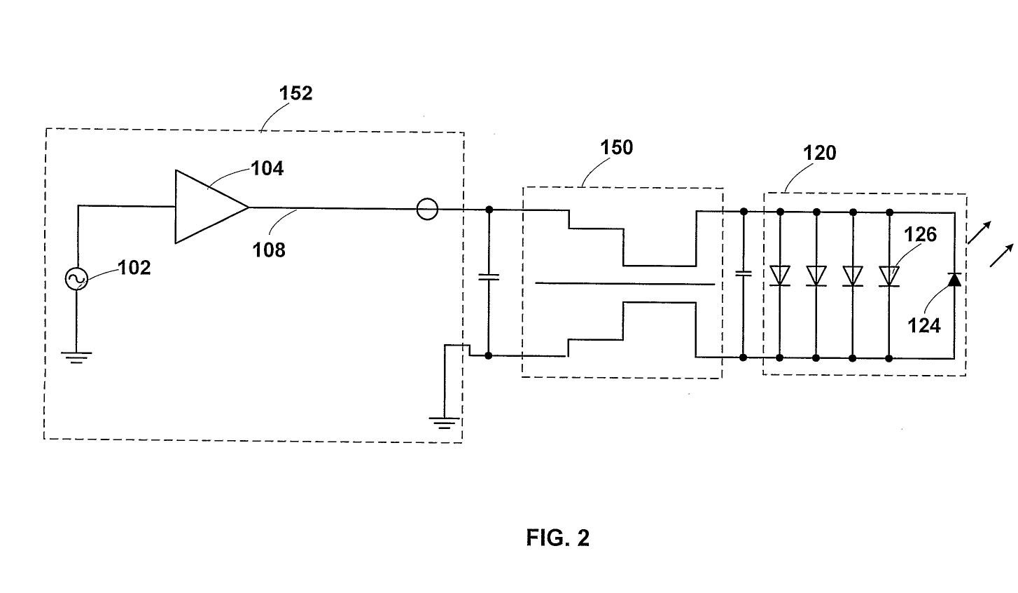

FIG. 2 is simplified schematic of the second exemplary embodiment of an electronic circuit useful in the implementation of the method, where quarter-wave matching sections arrangement 150 may be utilized to match the impedance of the high power signal generating section 152 and the laser diode block 120. The input section of quarter-wave matching sections arrangement 150 has an impedance matching the impedance of the transmission line 108 of power signal generating section 152 and the output section of arrangement 150 has an impedance matching the impedance of the low impedance device, which may be a laser diode block 120. The quarter-wave matching sections arrangement 150 serves as an impedance-transforming or matching device. The theory of using the quarter-wave matching sections is described for example in a book by P. Horowitz and W. Hill “The Art of Electronics”, Cambridge University Press, Second Edition, 1999, page 881. In this particular embodiment the quarter-wave matching sections are implemented as a printed circuit board having sections with different impedance.

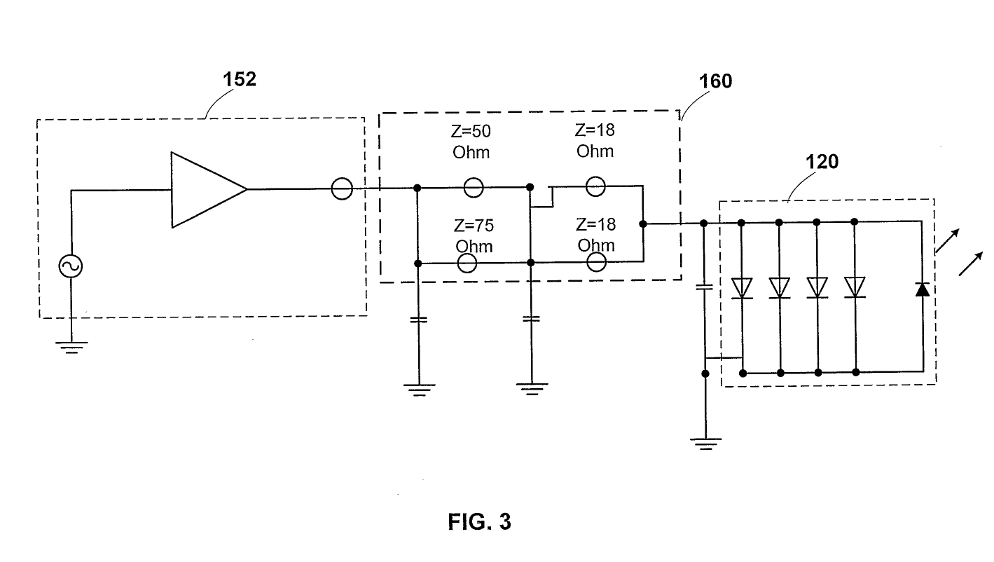

FIG. 3 is simplified schematic of the third exemplary embodiment of an electronic circuit useful in the implementation of the method. In this embodiment the quarter-wave matching sections are implemented as pieces of coaxial cables connected such that each section has a different impedance matching the impedance of the corresponding neighboring section.

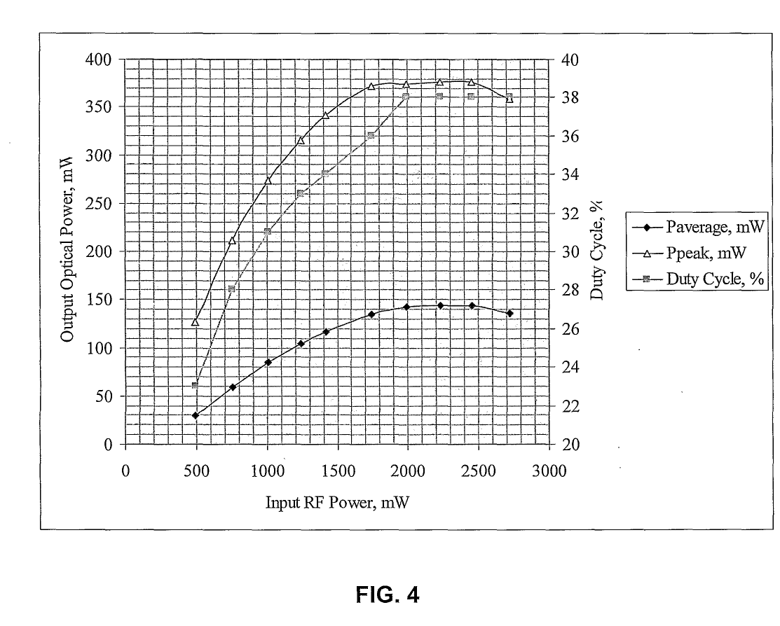

FIG. 4 illustrates the optical power of a laser diode in RF operation mode driven at a frequency of 100 MHz by driver of FIG. 1. The Pₚₑₐₖ power values were obtained by measuring with an optical power meter the average (P_{average}) laser diode power and correlating the laser pulse peak power with the pulse duty cycle. The method of matching impedance between the transforming sections and the laser diode that minimizes the power reflected into the amplifier and optimizes the diode driving pulse shape allows driving a commercial 50 mw laser diodes such as ML101J19-01 with continuous wave (CW) half-sine drive voltage at an overrated current at frequency of 100 MHz. Laser diode has shown good stability in RF (pulse) mode despite the continuous overrating of input power. The maximum optical peak power achieved was 360 mW.

The method disclosed supports separation between the location of the low impedance load and the bipolar signal power source. When applied to optical recording it simplifies the circuitry and heat removal from the system. Optical pick-up unit has lower weight and laser diode life is increased.

While the exemplary embodiment of the present method have been illustrated and described, it will be appreciated that various changes can be made therein without affecting the spirit and scope of the method. The scope of the method, therefore, is defined by reference to the following claims.

What is claimed:

1) A method of driving a block of diodes having low impedance by high power pulses, comprising generating a high power bipolar signal (106) and feeding it through an impedance transforming device (116, 150) to a block of diodes (120), characterized in that said block of diodes includes at least one laser diode (124) and said impedance transforming device (116, 150) is one of a group of transformer (116) or quarter wave matching section (150).

2) The method of claim 1, wherein the broadband amplifier (104) provides a high power bipolar input signal (106) to said impedance transforming device (116, 150);

3) The method of claim 1, wherein said impedance transforming device (116, 150) has an input impedance matching the output impedance of the broadband amplifier (104);

4) The method of claim 1, wherein said impedance transforming device (116, 150) has the output impedance substantially matching said diode block (120) impedance;

5) The method of claim 1, wherein said block of diodes (120) is constructed such that it protects said laser diode (124) by attenuating the opposite polarity to said driving laser diode (124) signal polarity;

6) The method of claim 1, wherein said laser diode (124) feed voltage offset protects said laser diode (124) protects said laser diode (124) from the damaging negative voltage drop.

7) The method of claim 1, wherein the bandwidth of said impedance transforming device (116, 150) limits said drive signal frequency range.

8) A method of driving a laser diode (124) by high power pulses (106), comprising:
a) generating a high power bipolar signal (106) and feeding said signal (106) into an input section of an impedance transforming device (116, 150);
b) coupling a block of diodes (120), said block of diodes (120) includes at least one laser diode (124), to an output section of said impedance transforming device (116, 150);
c) utilizing one of the polarities of said bipolar signal (106) to drive said laser diode (124).

9) The method of claim 8, wherein a broadband amplifier (104) provides said high power bipolar signal (106);

10) The method of claim 8, wherein said input section of said impedance transforming device (116, 150) has an impedance matching the output impedance of said broadband amplifier (104);

11) The method of claim 8, wherein said output section of said impedance transforming device (116, 150) has an impedance matching the impedance of said block of diodes (124);

12) The method of claim 8, wherein said diode block (120) is constructed such that it protects said laser diode (124) by attenuating the second polarity of said bipolar signal (106);

13) The method of claim 8, wherein said laser diode (124) feed voltage offset protects said laser diode (124) protects said laser diode (124) from the damaging negative voltage drop.

14) The method of claim 8, wherein said impedance transforming device (116, 150) bandwidth limits said signal (106) frequency range.

15) The method of claim 8, wherein said impedance transforming device (116, 150) is one of a group of transformer (116) or quarter wave matching section (150).

16) A method of driving a laser diode (124) by high power pulses, comprising:
a) providing a broadband amplifier (104) coupled to a standard transmission line (108), said transmission line (108) output end coupled to a primary winding (112) of a transformer (116);
b) providing a laser diode (124) coupled to a secondary winding (118) of said transformer (120), and
c) at least one diode (126) connected in parallel to said laser diode (124) in the direction opposite to said laser diode for protection of said laser diode.

17) The method of claim 16, wherein said broadband amplifier (104) provides a high power input signal (106) to said standard transmission line (108) having an impedance matching the output impedance of said broadband amplifier (104);

18) The method of claim 16, wherein said primary transformer winding (112) matches the transmission line (108) impedance;

19) The method of claim 16, wherein said secondary winding (118) matches said diode block (120) impedance;

20) A method of driving a laser diode (124) by high power pulses, comprising:
a) feeding a high power drive signal (106) through a quarter wave matching section (150);
b) coupling a laser diode (124) to the output of said quarter wave matching section (150), and
c) connecting in parallel to said laser diode (124) at least one diode (126) in the opposite to said laser diode direction.

21) The method of claim 20, wherein a broadband amplifier (104) provides the high power laser diode drive signal;

22) The method of claim 20, wherein the drive signal (106) frequency is limited by said quarter wave matching section (150) bandwidth;

23) The method of claim 20, wherein the output impedance of said quarter wave matching section (150) matches the impedance of said laser block (120);

24) The method of claim 20, wherein at least one said diode (126) connected in the opposite to said laser diode (124) direction protects said laser diode (124).
